(19) United States
(12) Patent Application Publication
(10) Pub. No.: US 2012/0202015 A1
(43) Pub. Date: Aug. 9, 2012

(54) METHOD FOR MANUFACTURING ADHESION BODY, METHOD FOR MANUFACTURING SUBSTRATE WITH ADHESIVE PATTERN, AND SUBSTRATE WITH ADHESIVE PATTERN

(76) Inventors: Aya IKEDA, Hitachi-shi (JP); Shinjiro Fujii, Hitachi-shi (JP); Takashi Kawamori, Tsukuba-shi (JP); Takashi Masuko, Tsukuba-shi (JP)

(21) Appl. No.: 13/365,311

(22) Filed: Feb. 3, 2012

Related U.S. Application Data
(60) Provisional application No. 61/439,452, filed on Feb. 4, 2011.

(30) Foreign Application Priority Data
Feb. 4, 2011 (JP) P2011-023133

(51) Int. Cl. B32B 3/00; B44C 1/22

(52) U.S. Cl. 428/195.1; 216/36; 216/41

(57) ABSTRACT

The method for manufacturing an adhesion body according to the present invention is a method for manufacturing an adhesion body in which a first adherend and a second adherend are bonded to each other via an adhesive pattern, comprising a step of providing an adhesive layer containing a thermosetting component on a first adherend; a step of forming an adhesive pattern by etching the adhesive layer in a state in which a protective layer for protecting a predetermined portion of the adhesive layer from etching is provided on a surface of the adhesive layer opposite to a surface in contact with the first adherend; and a step of bonding a second adherend to the adhesive pattern after the protective layer is removed.

### CROSS-REFERENCE TO RELATED APPLICATION

This application claims priority to Provisional Application Ser. No. 61/439,452 filed on Feb. 4, 2011 by the same Applicant, which is hereby incorporated by reference in its entirety.

### BACKGROUND OF THE INVENTION

1. Field of the Invention

The present invention relates to a method for manufacturing an adhesion body, a method for manufacturing a substrate with an adhesive pattern, and a substrate with an adhesive pattern.

2. Related Background Art

(1) A method of printing an adhesive on a substrate, (2) a method of punching an adhesion film, and (3) a method of providing an adhesive layer provided with photosensitivity on a substrate, and patterning the adhesive layer by exposure and development are known as a method for obtaining a patterned adhesive layer (hereinafter sometimes referred to as an adhesive pattern). As a photosensitive adhesive composition used in the method of (3), for example, photosensitive adhesive compositions containing polyimide compounds are disclosed in the following Patent Documents 1 to 3.
Patent Document 1: Japanese Patent Application Laid-Open Publication No. 5-197159
Patent Document 2: Japanese Patent Application Laid-Open Publication
Patent Document 3: Japanese Patent No. 4375481

### SUMMARY OF THE INVENTION

In the method of the above (1), continuous workability is low because the cleaning of a plate is necessary, and in addition, in this method, it is extremely difficult to keep flatness to ends, voids occur easily at an interface between the adhesive and an adherend, and sufficient adhesion strength may not be obtained due to the occurrence of unadhered portions.

In the method of the above (2), the film near cuts where stress is applied in punching deforms, and the flatness of an adhesive pattern decreases. Particularly when a fine adhesive pattern is formed or when an adhesion film having low elastic modulus is used, this decrease in flatness is not negligible, and voids occur at an interface between the adhesive and an adherend, and sufficient adhesion strength may not be obtained.

The photosensitive adhesive composition used in the method of the above (3) has the property of being easily infiltrated with a developer for patterning. Therefore, part of the adhesive composition in portions not removed in a development step is also dissolved in the developer, and there is a tendency that minute unevenness occurs on the surface of the adhesive composition obtained after the patterning. In this case, sufficient flatness is difficult to obtain on the adhesion surface of the adhesive layer, and voids occur at an interface between the adhesive and an adherend, and sufficient adhesion strength may not be obtained.

It is an object of the present invention to provide a method for manufacturing an adhesion body in which it is possible to suppress the occurrence of voids in bonding adherends together via an adhesive pattern, to obtain an adhesion body adhered with sufficient adhesion strength. In addition, it is an object of the present invention to provide a substrate with an adhesive pattern in which voids are less likely to occur and which can be bonded to an adherend with sufficient adhesion strength, and a method for manufacturing the same.

### Solution to Problem

In order to solve the above problems, the present invention provides a first method for manufacturing an adhesion body in which a first adherend and a second adherend are bonded to each other via an adhesive pattern, comprising a step of providing an adhesive layer containing a thermosetting component on a first adherend; a step of forming an adhesive pattern by etching the adhesive layer in a state in which a protective layer for protecting a predetermined portion of the adhesive layer from etching is provided on a surface of the adhesive layer opposite to a surface in contact with the first adherend; and a step of bonding a second adherend to the adhesive pattern after the protective layer is removed.

With the first method for manufacturing an adhesion body according to the present invention, an adhesive pattern surface is less likely to be damaged during etching, due to the presence of the above protective layer, and it is possible to form an adhesive pattern having a flat pattern surface. By bonding the second adherend to the adhesive pattern having a flat surface and containing the thermosetting component, it is possible to sufficiently suppress the occurrence of voids, and it is possible to obtain an adhesion body having sufficient adhesion strength.

It is preferred that the above adhesive layer further contain a thermoplastic resin having an imide skeleton in terms of heat resistance. The “heat resistance” refers to the peeling resistance when the above adhesive pattern is thermocompression-bonded to the first adherend and the second adherend, cured, and placed under high temperature.

The present invention also provides a second method for manufacturing an adhesion body in which a first adherend and a second adherend are bonded to each other via an adhesive pattern, comprising a step of providing an adhesive layer on a first adherend; a step of forming an adhesive pattern by etching the adhesive layer in a state in which a protective layer for protecting a predetermined portion of the adhesive layer from etching is provided on a surface of the adhesive layer opposite to a surface in contact with the first adherend; and a step of bonding a second adherend to the adhesive pattern after the protective layer is removed, wherein the adhesive layer is one in which the shear strength when the adhesive pattern bonded to the second adherend is cured is 1.2 times or more the shear strength before the curing of the adhesive pattern bonded to the second adherend.

With the second method for manufacturing an adhesion body according to the present invention, it is possible to sufficiently suppress the occurrence of voids, and it is possible to obtain an adhesion body having sufficient adhesion strength.

In the first and second method for manufacturing an adhesion body according to the present invention, it is preferred that the above protective layer be a resist pattern formed by providing a resist layer comprising a photosensitive resin composition on the surface of the above adhesive layer opposite to the surface in contact with the first adherend, and exposing and developing the resist layer. In this case, it is easy to obtain the resist pattern closely adhered to the adhesive, and the effect of being able to suppress the penetration of an etchant into an interface between the adhesive and the resist pattern is easily obtained.

In the first and second method for manufacturing an adhesion body according to the present invention, it is preferred that the etching be wet etching. With the method for manufacturing an adhesion body according to the present invention, even when wet etching in which patterning is possible at low cost is used, a pattern surface is less likely to be subjected to erosion by an etchant, due to the presence of the above protective layer, it is possible to form an adhesive pattern having a flat pattern surface, and it is possible to obtain an adhesion body having sufficient adhesion strength.

The present invention also provides a method for manufacturing a substrate with an adhesive pattern, comprising a step of providing an adhesive layer containing a thermosetting component on a substrate; and a step of forming an adhesive pattern by etching the adhesive layer in a state in which a protective layer for protecting a predetermined portion of the adhesive layer from etching is provided on a surface of the adhesive layer opposite to a surface in contact with the substrate.

With the method for manufacturing a substrate with an adhesive pattern according to the present invention, by comprising the above steps, it is possible to form an adhesive pattern having a flat pattern surface, and it is possible to obtain a substrate with an adhesive pattern that is excellent in stickiness to an adherend and adhesion strength.

It is preferred that the above adhesive layer further contain a thermoplastic resin having an imide skeleton in terms of heat resistance.

The present invention also provides a substrate with an adhesive pattern, comprising a substrate; and an adhesive pattern formed by etching an adhesive layer containing a thermosetting component provided on the substrate.

In the substrate with an adhesive pattern according to the present invention, the adhesive pattern is formed by etching the adhesive layer, and the substrate with an adhesive pattern according to the present invention can be one that has a flat adhesive pattern surface and is excellent in stickiness to an adherend and adhesion strength.

It is preferred that the above adhesive layer further contain a thermoplastic resin having an imide skeleton in terms of heat resistance.

### Advantageous Effects of Invention

According to the present invention, it is possible to provide a method for manufacturing an adhesion body in which by providing sufficient flatness to the adhesion surface of a patterned adhesive layer, it is possible to suppress the occurrence of voids in bonding adherends together via an adhesive pattern, to obtain an adhesion body adhered with sufficient adhesion strength. In addition, according to the present invention, it is possible to provide a substrate with an adhesive pattern having an adhesive provided with sufficient flatness in which voids are less likely to occur and which can be bonded to an adherend with sufficient adhesion strength, and a method for manufacturing the same.

### BRIEF DESCRIPTION OF THE DRAWINGS

FIGS. 1(a) and 1(b) are schematic cross-sectional views for explaining one embodiment of a method for manufacturing an adhesion body according to the present invention;

FIGS. 2(a) to 2(c) are schematic cross-sectional views for explaining one embodiment of the method for manufacturing an adhesion body according to the present invention;

FIG. 3 is a schematic cross-sectional view for explaining one embodiment of the method for manufacturing an adhesion body according to the present invention; and

FIG. 4 is a schematic cross-sectional view showing one embodiment of an adhesion body obtained by the method for manufacturing an adhesion body according to the present invention.

### DESCRIPTION OF THE PREFERRED EMBODIMENTS

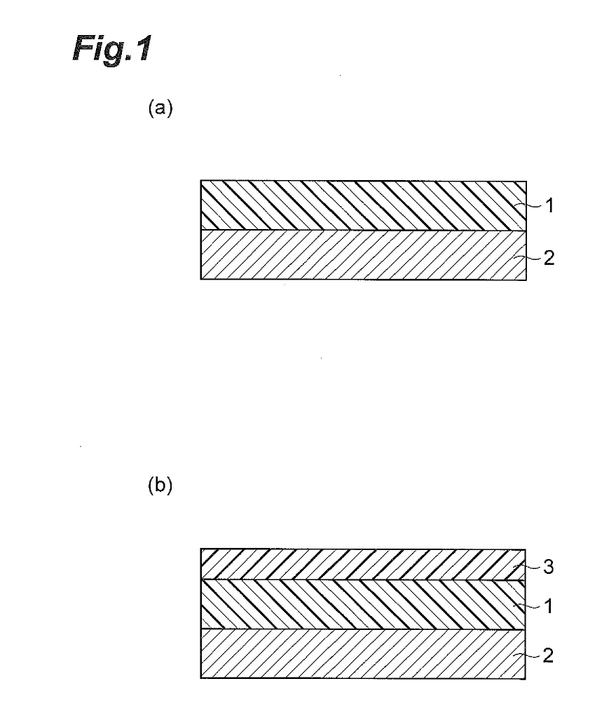

FIGS. 1(a) to 3 are schematic cross-sectional views for explaining one embodiment of a method for manufacturing an adhesion body according to the present invention. Each step of the method for manufacturing an adhesion body will be described below, based on these drawings.

FIG. 1(a) shows the step of providing an adhesive layer 1 containing a thermoplastic resin having an imide skeleton and a thermosetting component on a first adherend 2. A thermosetting component means a resin that causes a reaction by heat to form a polymer meshwork and is cured not to return to a former state, or a compound related to the above reaction.

Examples of the first adherend include glass substrates, transparent resin substrates, Si wafers, organic substrates, metal substrates, and ceramic substrates. Examples of the transparent resin substrates include transparent resin substrates comprising acrylic resins, polycarbonate resins, or styrene-based special transparent resins, such as methyl methacrylate-styrene resins, transparent ABS resins, or methyl methacrylate-butadiene-styrene.

The adhesive layer 1 can be formed, for example, by applying a liquid or pasty adhesive on the first adherend, or laminating a previously fabricated adhesive film on the first adherend.

Examples of the method of applying a liquid or pasty adhesive include publicly known methods, such as spinner methods, spraying methods, and immersion methods. Examples of drying conditions after the application include the conditions of less than 180° C., preferably 10 to 150° C., for 1 minute to 40 minutes.

Examples of the method of laminating an adhesive film include publicly known methods, such as roll lamination and vacuum lamination. Examples of the conditions of the lamination include conditions in which lamination temperature is preferably equal to or higher than the glass transition temperature (Tg) of the adhesion film, is preferably a temperature at which the thermosetting component does not react, and is in the range of 10° C. to 180° C., roll pressure is 0.001 N/cm or more, and roll speed is 0.01 mm/s or more.

In this embodiment, it is preferred to form the adhesive layer 1 by thermocompression-bonding an adhesive film to the adherend to laminate the adhesive film. Examples of reasons for this include the number of steps for fowling the adhesive layer being smaller, pot life being longer, bleeding being less, and flatness being higher, compared with a liquid or pasty adhesive. Thus, it is possible to improve precision processability.

Examples of the thermoplastic resin having an imide skeleton contained in the adhesive layer 1 include polyimide resins, polyamide resins, polyamideimide resins, polyetherimide resins, polyester resins, siloxane polyimide resins, polyesterimide resins, and resins having an imide skeleton in a side chain.

Examples of the thermosetting component include thermosetting resins, curing agents and curing accelerators. When a thermosetting resin is mixed, a curing agent can be used in combination. In the present invention, thermosetting resins refer to reactive compounds that can cause a crosslinking reaction by heat. Examples of such compounds include epoxy resins, cyanate resins, bismaleimide resins, phenolic resins, urea resins, melamine resins, alkyd resins, acrylic resins, unsaturated polyester resins, diallyl phthalate resins, silicone resins, resorcinol formaldehyde resins, xylene resins, furan resins, polyurethane resins, ketone resins, triallyl cyanurate resins, polyisocyanate resins, resins containing tris(2-hydroxyethyl) isocyanurate, resins containing triallyl trimellitate, thermosetting resins synthesized from cyclopentadiene, and thermosetting resins obtained by the trimerization of aromatic dicyanamides. Among them, epoxy resins, cyanate resins, and bismaleimide resins are preferred in terms of being able to have excellent adhesion at high temperature, and epoxy resins are particularly preferred in terms of handling properties and compatibility with the resin having an imide skeleton. These thermosetting resins can be used alone or in combination of two or more types.

When an epoxy resin is used, it is preferred to use a curing agent or a curing accelerator for the epoxy resin, and it is more preferred to use these in combination. Examples of the curing agent include phenolic compounds, aliphatic amines, alicyclic amines, aromatic polyamines, polyamides, aliphatic acid anhydrides, alicyclic acid anhydrides, aromatic acid anhydrides, dicyandiamide, organic acid dihydrazides, boron trifluoride-amine complexes, imidazoles, tertiary amines, and phenolic compounds having at least two phenolic hydroxyl groups in a molecule. Among these, phenolic compounds having at least two phenolic hydroxyl groups in a molecule are preferred in terms of being excellent in solubility in an alkali aqueous solution.

A curing accelerator, a filler, a coupling agent, and the like can be contained in the adhesive layer 1.

The curing accelerator is not particularly limited as long as it accelerates the curing of the epoxy resin, and examples of the curing accelerator include imidazoles, dicyandiamide derivatives, dicarboxylic acid dihydrazide, triphenylphosphine, tetraphenylphosphonium tetraphenylborate, 2-ethyl-4-methylimidazole-tetraphenylborate, and 1,8-diazabicyclo[5.4.0]undecene-7-tetraphenylborate.

Examples of the filler include metal fillers, such as silver powder, gold powder, and copper powder, nonmetal inorganic fillers, such as silica, alumina, boron nitride, titania, glass, iron oxide, aluminum borate, and ceramic, and organic fillers, such as carbon and rubber-based fillers.

Examples of the coupling agent include silane coupling agents and titanium-based coupling agents, and among them, silane coupling agents are preferred in terms of being able to provide high adhesion.

Further, in this embodiment, it is preferred to form the adhesive layer 1, using the following adhesive film:

an adhesion film containing (A) a polyimide resin obtained by reacting a tetracarboxylic dianhydride, in which 70 mole % or more of a tetracarboxylic dianhydride represented by formula (I) or formula (II) is contained with respect to all acid dianhydrides, with a diamine, (B) an epoxy resin, (C) a phenolic resin, (D) a curing accelerator, and (E) an inorganic substance filler.

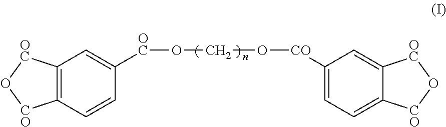

wherein n represents an integer of 2 to 20.

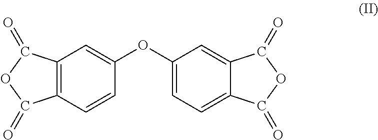

Examples of the tetracarboxylic dianhydride represented by formula (I) include ethylenebistrimellitate dianhydride, trimethylenebistrimellitate dianhydride, tetramethylenebistrimellitate dianhydride, pentamethylenebistrimellitate dianhydride, hexamethylenebistrimellitate dianhydride, heptamethylenebistrimellitate dianhydride, octamethylenebistrimellitate dianhydride, nonamethylenebistrimellitate dianhydride, decamethylenebistrimellitate dianhydride, dodecamethylenebistrimellitate dianhydride, hexadecamethylenebistrimellitate dianhydride, and octadecamethylenebistrimellitate dianhydride. Two or more of these may be used in combination.

These tetracarboxylic dianhydrides can be synthesized from trimellitic anhydride monochloride and corresponding diols. It is preferred that 70 mole % or more of the above tetracarboxylic dianhydride be contained with respect to all tetracarboxylic dianhydrides. If the above tetracarboxylic dianhydride is less than 70 mole %, temperature at the time of the bonding of the adhesion film increases, which is unpreferred.

Examples of a tetracarboxylic anhydride that can be used with the tetracarboxylic dianhydride of formula (I) include pyromellitic dianhydride, 3,3′,4,4′-diphenyltetracarboxylic dianhydride, 2,2′,3,3′-diphenyltetracarboxylic dianhydride, 2,2-bis(3,4-dicarboxyphenyl)propane dianhydride, 2,2-bis(2,3-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, bis(3,4-dicarboxyphenyl)sulfone dianhydride, 3,4,9,10-perylenetetracarboxylic dianhydride, bis(3,4-dicarboxyphenyl)ether dianhydride, benzene-1,2,3,4-tetracarboxylic dianhydride, 3,4,3′,4′-benzophenonetetracarboxylic dianhydride, 2,3,2′,3-benzophenonetetracarboxylic dianhydride, 2,3,3′,4′-benzophenonetetracarboxylic dianhydride, 1,2,5,6-naphthalenetetracarboxylic dianhydride, 2,3,6,7-naphthalenetetracarboxylic dianhydride, 1,2,4,5-naphthalene-tetracarboxylic dianhydride, 1,4,5,8-naphthalene-tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, thiophene-2,3,4,5-tetracarboxylic dianhydride, 2,3,3′,4′-biphenyltetracarboxylic dianhydride, 3,4,3′,4′-biphenyltetracarboxylic dianhydride, 2,3,2′,3′-biphenyltetracarboxylic dianhydride, bis(3,4-dicarboxyphenyl)dimethylsilane dianhydride, bis(3,4-dicarboxyphenyl)methylphenylsilane dianhydride, bis(3,4-dicarboxyphenyl)diphenylsilane dianhydride, 1,4-bis(3,4-dicarboxyphenyldimethylsilyl)benzene dianhydride, 1,3-bis(3,4-dicarboxyphenyl)-1,1,3,3-tetramethyldicyclohexane dianhydride, p-phenylbis(trimellitic acid monoester acid anhydride), ethylenetetracarboxylic dianhydride, 1,2,3,4-butanetetracarboxylic dianhydride, decahydronaphthalene-1,4,5,8-tetracarboxylic dianhydride, 4,8-dimethyl-1,2,3,6,7-hexahydronaphthalene-1-tetracarboxylic dianhydride, cyclopentane-1,2,3,4-tetracarboxylic dianhydride, pyrrolidine-2,3,4,5-tetracarboxylic dianhydride, 1,2,3,4-cyclobutanetetracarboxylic dianhydride, bis(exo-bicyclo[2,2,1]heptane-2,3-dicarboxylic anhydride)sulfone, bicyclo-(2,2,2)-octo(7)-ene 2,3,5,6-tetracarboxylic dianhydride, 2,2-bis(3,4-dicarboxyphenyl)hexafluoropropane dianhydride, 2,2-bis[4-(3,4-dicarboxyphenoxy)phenyl]hexafluoropropane dianhydride, 4,4′-bis(3,4-dicarboxyphenoxy)diphenyl sulfide dianhydride, 1,4-bis(2-hydroxyhexafluoroisopropyl)benzenebis(trimellitic anhydride), 1,3-bis(2-hydroxyhexafluoroisopropyl)benzenebis(trimellitic anhydride), 5-(2,5-dioxotetrahydrofuryl)-3-methyl-3-cyclohexene-1,2-dicarboxylic anhydride, and tetrahydrofuran-2,3,4,5-tetracarboxylic dianhydride. These may be used by mixing two or more types.

Examples of the diamine can include aliphatic diamines, such as 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, and 1,12-diaminododecane, and aromatic diamines, such as o-phenylenediamine, m-phenylenediamine, p-phenylenediamine, 3,3′-diaminodiphenyl ether, 3,4′-diaminodiphenyl ether, 4,4′-diaminodiphenyl ether, 3,3′-diaminodiphenylmethane, 3,4′-diaminodiphenylmethane, 4,4′-diaminodiphenylmethane, 3,3′-diaminodiphenyldifluoromethane, 3,4′-diaminodiphenyldifluoromethane, 4,4′-diaminodiphenyldifluoromethane, 3,3′-diaminodiphenyl sulfone, 3,4′-diaminodiphenyl sulfone, 4,4′-diaminodiphenyl sulfone, 3,3′-diaminodiphenyl sulfide, 3,4′-diaminodiphenyl sulfide, 4,4′-diaminodiphenyl sulfide, 3,3′-diaminodiphenyl ketone, 3,4′-diaminodiphenyl ketone, 4,4′-diaminodiphenyl ketone, 2,2-bis(3-aminophenyl)propane, 2,2′-(3,4′-diaminodiphenyl)propane, 2,2-bis(4-aminophenyl)propane, 2,2-bis(3-aminophenyl)hexafluoropropane, 2,2-(3,4′-diaminodiphenyl)hexafluoropropane, 2,2-bis(4-aminophenyl)hexafluoropropane, 1,3-bis(3-aminophenoxy)benzene, 1,4-bis(3-aminophenoxy)benzene, 1,4-bis(4-aminophenoxy)benzene, 3,3′-(1,4-phenylenebis(1-methylethylidene))bisaniline, 3,4′-(1,4-phenylenebis(1-methylethylidene))bisaniline, 4,4′-(1,4-phenylenebis(1-methylethylidene))bisaniline, 2,2-bis(4-(3-aminophenoxy)phenyl)propane, 2,2-bis(4-(4-aminophenoxy)phenyl)propane, 2,2-bis(4-(3-aminophenoxy)phenyl)hexafluoropropane, 2,2-bis(4-(4-aminophenoxy)phenyl)hexafluoropropane, bis(4-(3-aminophenoxy)phenyl)sulfide, bis(4-(4-aminophenoxy)phenyl)sulfide, bis(4-(3-aminophenoxy)phenyl)sulfone, bis(4-(4-aminophenoxy)phenyl)sulfone, 3,3′-dimethoxy-4,4′-diaminobiphenyl, 4,4′-methylene-bis(2,6-diethylaniline), o-tolidine sulfone, 1,4-bis(4-aminophenoxy)benzene, 4,4-methylene-bis(2,6-diisopropylaniline), 4,4′-bis(4-aminophenoxy)biphenyl, 1,1-bis(4-(4-aminophenoxy)phenyl)cyclohexane, and 1,3-bis(3-aminopropyl)tetramethyldisiloxane

As diamines used for synthesis of polyimide, the aliphatic ether diamine represented by formula (III) or the siloxane diamine represented by formula (IV) is preferred in order to make solubility in an etchant particularly good.

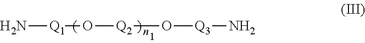

in formula (III), Q₁, Q₂ and Q₃ each independently represent an alkylene group having 1 to 10 carbons; and n₁ represents an integer of 1 to 80.

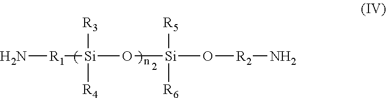

in formula (IV), R₁ and R₂ each independently represent an alkylene group having 1 to 5 carbons or a phenylene group which may have a substituent; R₃, R₄, R₅ and R₆ each independently represent an alkyl group having 1 to 5 carbons, a phenyl group or a phenoxy group; and n₂ represents an integer of 1 to 5.

Examples of the commercial products of the aliphatic ether diamine represented by formula (III) include “JEFFAMINE D-230”, “D-400”, “D-2000”, “D-4000”, “ED-600”, “ED-900”, “ED-201”, “EDR-148” (these are trade name), manufactured by SunTechnochemicals Co., Ltd., and “polyetheramine D-230”, “D-400”, “D-2000” (these are trade name), manufactured by BASF.

Examples of the siloxane diamine represented by formula (IV) include, when n₂ is 1, 1,1,3,3-tetramethyl-1,3-bis(4-aminophenyl)disiloxane, 1,1,3,3-tetraphenoxy-1,3-bis(4-aminoethyl)disiloxane, 1,1,3,3-tetraphenyl-1,3-bis(2-aminoethyl)disiloxane, 1,1,3,3-tetraphenyl-1,3-bis(3-aminopropyl)disiloxane, 1,1,3,3-tetramethyl-1,3-bis(2-aminoethyl)disiloxane, 1,1,3,3-tetramethyl-1,3-bis(3-aminopropyl)disiloxane, 1,1,3,3-tetramethyl-1,3-bis(3-aminobutyl)disiloxane, and 1,3-dimethyl-1,3-dimethoxy-1,3-bis(4-aminobutyl)disiloxane, and when n₂ is 2, examples of the siloxane diamine include 1,1,3,3,5,5-hexamethyl-1,5-bis(4-aminophenyl)trisiloxane, 1,1,5,5-tetraphenyl-3,3-dimethyl-1,5-bis(3-aminopropyl)trisiloxane, 1,1,5,5-tetraphenyl-3,3-dimethoxy-1,5-bis(4-aminobutyl)trisiloxane, 1,1,5,5-tetraphenyl-3,3-dimethoxy-1,5-bis(5-aminopentyl)trisiloxane, 1,1,5,5-tetramethyl-3,3-dimethoxy-1,5-bis(2-aminoethyl)trisiloxane, 1,1,5,5-tetramethyl-3,3-dimethoxy-1,5-bis(4-aminobutyl)trisiloxane, 1,1,5,5-tetramethyl-3,3-dimethoxy-1,5-bis(5-aminopentyl)trisiloxane, 1,1,3,3,5,5-hexamethyl-1,5-bis(3-aminopropyl)trisiloxane, 1,1,3,3,5,5-hexaethyl-1,5-bis(3-aminopropyl)trisiloxane, and 1,1,3,3,5,5-hexapropyl-1,5-bis(3-aminopropyl)trisiloxane.

These diamines can be used alone or in combination of two or more types.

It is preferred that the used amount of the aliphatic ether diamine represented by formula (III) or the siloxane diamine represented by formula (IV) be 40 to 90 mole % (further preferably 50 to 90 mole %) with respect to all diamines. If the used amount of the above aliphatic ether diamine or the above siloxane diamine is less than 40 mole % with respect to all diamines, solubility in the etchant becomes slow, and if the used amount of the above aliphatic ether diamine or the above siloxane diamine is more than 90 mole %, Tg of polyimide decreases, tackiness of the film surface becomes strong, and there is a tendency that voids occur easily during the thermocompression-bonding.

Diamines may include other diamines than those described above. Examples of the other diamines include o-phenylenediamine, m-phenylenediamine, p-phenylenediamine, 3,3′-diaminodiphenyl ether, 3,4′-diaminodiphenyl ether, 4,4′-diaminodiphenyl ether, 3,3′-diaminodiphenylmethane, 3,4′-diaminodiphenylmethane, 4,4′-diaminodiphenylmethane, bis(4-amino-3,5-dimethylphenyl)methane, bis(4-amino-3,5-diisopropylphenyl)methane, 3,3′-diaminodiphenyldifluoromethane, 3,4′-diaminodiphenyldifluoromethane, 4,4′-diaminodiphenyldifluoromethane, 3,3′-diaminodiphenyl sulfone, 3,4′-diaminodiphenyl sulfone, 4,4′-diaminodiphenyl sulfone, 3,3′-diaminodiphenyl sulfide, 3,4′-diaminodiphenyl sulfide, 4,4′-diaminodiphenyl sulfide, 3,3′-diaminodiphenyl ketone, 3,4′-diaminodiphenyl ketone, 4,4′-diaminodiphenyl ketone, 2,2-bis(3-aminophenyl)propane, 2,2′-(3,4′-diaminodiphenyl)propane, 2,2-bis(4-aminophenyl)propane, 2,2-bis(3-aminophenyl)hexafluoropropane, 2,2-(3,4′-diaminodiphenyl)hexafluoropropane, 2,2-bis(4-aminophenyl)hexafluoropropane, 1,3-bis(3-aminophenoxy)benzene, 1,4-bis(3-aminophenoxy)benzene, 1,4-bis(4-aminophenoxy)benzene, 3,3′-(1,4-phenylenebis(1-methylethylidene))bisaniline, 3,4′-(1,4-phenylenebis(1-methylethylidene))bisaniline, 4,4′-(1,4-phenylenebis(1-methylethylidene))bisaniline, 2,2-bis(4-(3-aminophenoxy)phenyl)propane, 2,2-bis(4-(3-aminophenoxy)phenyl)hexafluoropropane, 2,2-bis(4-(4-aminophenoxy)phenyl)hexafluoropropane, bis(4-(3-aminophenoxy)phenyl)sulfide, bis(4-(4-aminophenoxy)phenyl)sulfide, bis(4-(3-aminophenoxy)phenyl)sulfone, bis(4-(4-aminophenoxy)phenyl)sulfone, 1,3-bis(aminomethyl)cyclohexane and 2,2-bis(4-aminophenoxyphenyl)propane.

Particularly preferred combination of an acid and a diamine is a tetracarboxylic dianhydride in which 70 mole % or more of the tetracarboxylic dianhydride represented by formula (I) or formula (II) is contained with respect to all acid dianhydrides, and a diamine in which 40 to 90 mole % (further preferably 50 to 90 mole %) of the aliphatic ether diamine represented by formula (III) or the siloxane diamine represented by formula (IV) is contained with respect to all diamines.

The condensation reaction of the tetracarboxylic dianhydride with the diamine can be performed in an organic solvent. In this case, equal or substantially equal moles of the tetracarboxylic dianhydride and the diamine are preferably used, and the addition order of the components is arbitrary. Examples of the organic solvent used include dimethylacetamide, dimethylformamide, N-methyl-2-pyrrolidone, dimethyl sulfoxide, hexamethylphosphorylamide, m-cresol, and o-chlorophenol.

Reaction temperature is preferably 80° C. or less, more preferably 0 to 50° C. As the reaction proceeds, the viscosity of a reaction liquid increases gradually. In this case, a polyamide acid that is a precursor of a polyimide is produced.

The polyimide resin can be obtained by subjecting a reaction product (polyamide acid) obtained above to dehydration and ring closure. The dehydration and ring closure can be performed using a method of performing heat treatment at 120° C. to 250° C., or a chemical method. In the case of the method of performing heat treatment at 120° C. to 250° C., it is preferred to perform the method, while removing water produced in a dehydration reaction out of a system. At this time, the water may be azeotropically removed, using benzene, toluene, xylene, or the like.

In the case of performing dehydration and ring closure by the chemical method, an acid anhydride, such as acetic anhydride, propionic anhydride, or benzoic anhydride, a carbodiimide compound, such as dicyclohexylcarbodiimide, or the like is used as a ring closure agent. At this time, a ring closure catalyst, such as pyridine, isoquinoline, trimethylamine, aminopyridine, or imidazole, may be used as required. The ring closure agent or the ring closure catalyst is preferably used in the range of 1 to 8 moles with respect to 1 mole of the tetracarboxylic dianhydride.

(B) the epoxy resin is one containing at least two epoxy groups in a molecule, and in terms of curability and cured product properties, a phenol glycidyl ether type epoxy resin is preferably used. Examples of such a resin include condensates of bisphenol A, bisphenol AD, bisphenol S, bisphenol F, or halogenated bisphenol A and epichlorohydrin, glycidyl ethers of phenol novolac resins, glycidyl ethers of cresol novolac resins, and glycidyl ethers of bisphenol A novolac resins. Two or more of these may be used in combination. The amount of the epoxy resin mixed is preferably 1 to 100 parts by mass, more preferably 5 to 60 parts by mass, with respect to 100 parts by mass of the polyimide resin. If the amount of the epoxy resin mixed is less than the above lower limit value, there is a tendency that adhesiveness worsens, and if the amount of the epoxy resin mixed is more than the above upper limit value, there is a tendency that etching takes time and workability is poor.

(C) the phenolic resin is one having at least two phenolic hydroxyl groups in a molecule, and examples of the phenolic resin include phenol novolac resins, cresol novolac resins, bisphenol A novolac resins, poly-p-vinylphenol, and phenol aralkyl resins. Two or more of these may be used in combination. The amount of the phenolic resin mixed is preferably 2 to 150 parts by mass, more preferably 50 to 120 parts by mass, with respect to 100 parts by mass of the epoxy resin. If the amount of the phenolic resin mixed is out of the above range, sufficient curability is difficult to obtain.

(D) the curing accelerator is not particularly limited as long as it is used for curing the epoxy resin. As such one, for example, imidazoles, dicyandiamide derivatives, dicarboxylic acid dihydrazide, triphenylphosphine, tetraphenylphosphonium tetraphenylborate, 2-ethyl-4-methylimidazole-tetraphenylborate, or 1,8-diazabicyclo(5,4,0)undecene-7-tetraphenylborate is used. Two or more of these may be used in combination. The amount of the curing accelerator mixed is preferably 0.01 to 50 parts by mass, more preferably 0.1 to 20 parts by mass, with respect to 100 parts by mass of the epoxy resin. If the amount of the curing accelerator mixed is less than the above lower limit value, sufficient curability is difficult to obtain, and if the amount of the curing accelerator mixed is more than the above upper limit value, there is a tendency that storage stability decreases.

(E) the inorganic substance filler is one added for the purpose of providing low thermal expansion properties and a low moisture absorption rate to the adhesive, and it is possible to use inorganic insulators, such as silica, alumina, titania, glass, iron oxide, and ceramic, alone or by mixing two or more of them. The amount of the inorganic substance filler mixed is preferably 1 to 8000 parts by mass, more preferably 50 to 4000 parts by mass, with respect to 100 parts by mass of the polyimide resin. If the amount of the inorganic substance filler mixed is less than the above lower limit value, sufficient low thermal expansion properties and low moisture absorption properties are difficult to obtain, and if the amount of the inorganic substance filler mixed is more than the above upper limit value, there is a tendency that adhesiveness decreases.

A silane coupling agent, a titanium-based coupling agent, a nonionic surfactant, a fluorine-based surfactant, a silicone-based additive, and the like may be appropriately added to the adhesion film as required.

The adhesion film can be manufactured as follows. First, an epoxy resin, a phenolic resin, and a polyimide resin are dissolved in an organic solvent. The organic solvent used here is not particularly limited as long as the above materials can be uniformly dissolved or kneaded, and examples of such include dimethylformamide, dimethylacetamide, N-methylpyrrolidone, dimethyl sulfoxide, diethylene glycol dimethyl ether, toluene, benzene, xylene, methyl ethyl ketone, tetrahydrofuran, ethyl cellosolve, ethyl cellosolve acetate, butyl cellosolve, and dioxane. Then, a curing accelerator, an inorganic substance filler, and additives as required are added and mixed. In this case, kneading may be performed by appropriately combining a usual stirrer, grinding machine, and dispersion machine, such as three rolls or a ball mill. By uniformly applying the thus obtained pasty mixture on a base film, for example, a sheet made of propylene, and heating the pasty mixture under conditions in which the solvent used volatilizes sufficiently, for example, at a temperature of 60 to 200° C. for 0.1 to 30 minutes, the adhesion film is obtained.

FIG. 1(b) shows the step of providing a resist 3 (resist layer) on a surface of the adhesive layer 1 opposite to a surface in contact with the first adherend 2. In this embodiment, the resist layer is provided as a protective layer for protecting a predetermined portion of the adhesive layer from etching.

The resist 3 can be formed, for example, by applying a liquid or pasty photosensitive resin composition on the adhesive layer 1, or laminating a previously fabricated dry film resist on the adhesive layer 1.

Examples of the method of applying a liquid or pasty photosensitive resin composition include publicly known methods, such as spinner methods, spraying methods, and immersion methods. Examples of drying conditions after the application include the conditions of less than 180° C., preferably 10 to 150° C., for 1 minute to 40 minutes.

Examples of the method of laminating a dry film resist include publicly known methods, such as roll lamination and vacuum lamination. Examples of the conditions of the lamination include 0 to 180° C., 0.001 N or more, and a roll speed of 0.01 mm/s or more.

In this embodiment, it is preferred to form the resist layer by thermocompression-bonding a dry film resist to the adhesive layer to laminate the dry film resist. Examples of reasons for this include the number of steps for forming the resist layer being smaller, pot life being longer, bleeding being less, and flatness being higher, compared with a liquid or pasty photosensitive resin composition. Thus, it is possible to improve precision processability.

The dry film resist being capable of being developed with an alkali aqueous solution and being capable of being stripped with an alkali aqueous solution is a preferred mode as the dry film resist. By performing such development with an alkali aqueous solution and stripping with an alkali aqueous solution, an advantage is that there is no problem with the disposal of a spent organic solvent.

The dry film resist is specifically obtained by the mixing of a polymer binder, monofunctional and/or polyfunctional monomers, a photopolymerization initiator, and other additives, and can usually be manufactured by applying a mixed solution thereof to a substrate such as a film.

The polymer binder is mixed in the dry film resist for the purposes of maintaining the form of the dry film resist, providing developability, and the like, and is a component corresponding to what is called the framework of the dry film resist. As such a polymer binder, acrylic resins can be mainly used, and in addition, polyesters, polyamides, polyethers, polyallylamines, and the like can be used. In addition, the weight-average molecular weight of the polymer binder is preferably 6000 or more, in terms of maintaining a shape as the dry film resist, and the weight-average molecular weight is preferably 100000 or less, in terms of developability.

It is possible to introduce an acidic functional group into the polymer binder in the case of alkali development and introduce a basic functional group into the polymer binder in the case of acid development in order to provide developability. Examples of the acidic functional group include a carboxyl group and a hydroxyl group. Examples of the basic functional group include an amino group.

The polyfunctional monomer and the monofunctional monomer have the function of decreasing the solubility of the dry film resist by reacting with the polymer binder and other polyfunctional monomers due to a radical, generated by the photopolymerization initiator by irradiation with ultraviolet rays or the like, to form a crosslinked structure.

Specific examples of the above monomers include polyoxyalkylene glycol di(meth)acrylates, such as 1,6-hexanediol di(meth)acrylate, 1,4-cyclohexanediol di(meth)acrylate, polypropylene glycol di(meth)acrylate, polyethylene glycol di(meth)acrylate, and polyoxyethylene polyoxypropylene glycol di(meth)acrylate, 2-di(p-hydroxyphenyl)propane di(meth)acrylate, glycerol tri(meth)acrylate, trimethylolpropane tri(meth)acrylate, polyoxypropyltrimethylolpropane tri(meth)acrylate, polyoxyethyltrimethylolpropane triacrylate, dipentaerythritol penta(meth)acrylate, trimethylolpropane triglycidyl ether tri(meth)acrylate, bisphenol A diglycidyl ether di(meth)acrylate, 2,2-bis(4-methacryloxypentaethoxyphenyl)propane, polyfunctional (meth)acrylates containing a urethane group, and polyfunctional methacrylates or acrylates containing bisphenol A in a structure.

Examples of the photopolymerization initiator include those that absorb electromagnetic waves, particularly ultraviolet rays, perform cleavage and/or the abstraction of hydrogen from other molecules, and generate a radical, for example, quinones, such as 2-ethylanthraquinone, octaethylanthraquinone, 1,2-benzanthraquinone, 2,3-benzanthraquinone, 2-phenylanthraquinone, 2,3-diphenylanthraquinone, 1-chloroanthraquinone, 2-chloroanthraquinone, 2-methylanthraquinone, 1,4-naphthoquinone, 9,10-phenanthraquinone, 2-methyl 1,4-naphthoquinone, 2,3-dimethylanthraquinone, and 3-chloro-2-methylanthraquinone; aromatic ketones, such as benzophenone, Michler's ketone[4,4′-bis(dimethylamino)benzophenone], and 4,4′-bis(diethylamino)benzophenone; benzoin, and benzoin ethers, such as benzoin ethyl ether, benzoin phenyl ether, methylbenzoin, and ethylbenzoin; benzyl dimethyl ketal, benzyl diethyl ketal, and biimidazole compounds, such as a 2-(o-chlorophenyl)-4,5-diphenylimidazolyl dimer; combinations of thioxanthones and alkylaminobenzoic acids, for example, a combination of ethylthioxanthone and dimethylaminobenzoic acid ethyl, a combination of 2-chlorothioxanthone and dimethylaminobenzoic acid ethyl, and a combination of isopropylthioxanthone and dimethylaminobenzoic acid ethyl, and a combination of a 2-(o-chlorophenyl)-4,5-diphenylimidazolyl dimer and Michler's ketone; acridines, such as 9-phenylacridine; and oxime esters, such as 1-phenyl-1,2-propanedione-2-o-benzoyloxime, and 1-phenyl-1,2-propanedione-2-(o-ethoxycarbonyl)oxime.

Examples of the other additives include coloring matters that increase the efficiency of absorption of emitted electromagnetic waves, and plasticizers that provide flexibility to the dry film itself.

The dry film resist is preferably one in which development and stripping with an alkali aqueous solution can be performed, but is not particularly limited as long as it has resistance to an etchant and can maintain a pattern shape while the resist layer is wet-etched.

Examples of the one in which development and stripping with an alkali aqueous solution can be performed include SUNFORT series (trade name) manufactured by Asahi Chemical Industry Co., Ltd., ALPHO series (trade name) and LAMINAR series (trade name) manufactured by Nichigo-Morton Co., Ltd., and RAY series (trade name) manufactured by Hitachi Chemical Co., Ltd. In addition, it is also possible to use a commercial lactic acid development and lactic acid stripping type dry film resist SFP-00GI-25AR (trade name, manufactured by Nippon Steel Chemical Co., Ltd.) and the like.

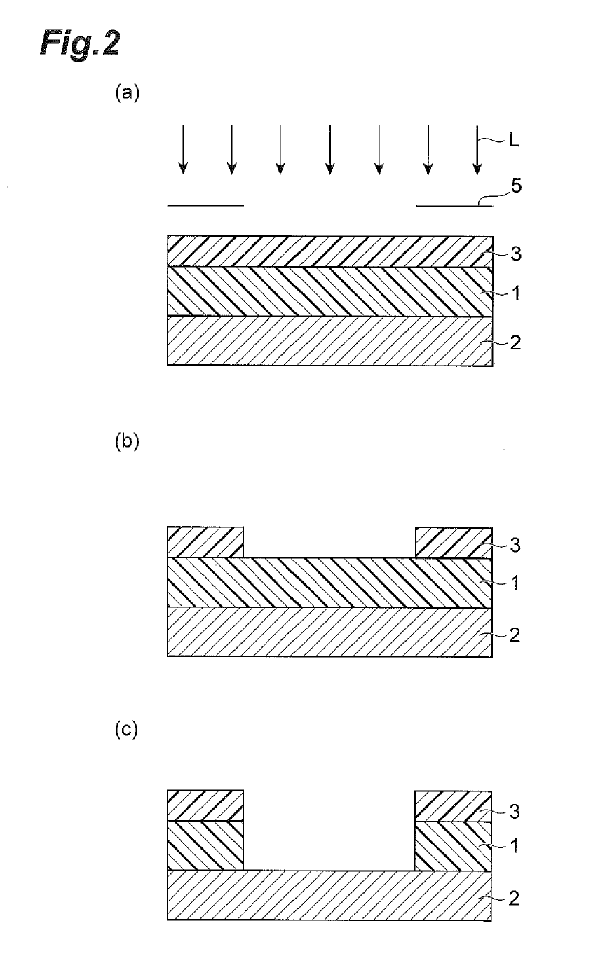

FIG. 2(a) shows the step of exposing the resist 3 with a predetermined pattern via a mask 5, and FIG. 2(b) shows one in which a resist pattern is formed by subsequent development.

The exposure can be performed by a publicly known method, such as a photolithography method, and it is also possible to use a direct writing method, other than exposure via a mask. A developer for the resist is appropriately selected according to the type of the resist, and it is possible to use, for example, a solvent or an alkali developer, but alkali development is preferred in terms of waste liquid disposal. The resist may be formed by a printing method, not by a resist exposure and development method.

FIG. 2(c) shows the step of etching the adhesive layer 1 in a state in which the resist 3 (resist pattern) for protecting a predetermined portion of the adhesive layer 1 from etching is provided. Here, the predetermined portion refers to an adhesive pattern to be formed, and by the resist layer being provided on this, a surface of the adhesive layer to be stuck to a second adherend is protected, and an adhesive pattern having a flat pattern surface is formed.

Examples of the method of etching include wet etching using an etchant, and dry etching with a laser or a gas. However, problems of the method of performing processing by a dry etching method with plasma or the like are that equipment is expensive, initial expense is required very much, processing time is also long, and manufacturing cannot be efficiently performed, and therefore, wet etching in which processing can be performed at low cost is more preferred.

In this embodiment, a wet etching method with an etchant is preferred. As an etchant, those containing a strong alkali, water are preferred, and more preferably, those further containing a nucleophilic agent are preferred. Specifically, examples of the etchant include those in which an alkali metal, oxyalkylamine, water, and the like are contained, those in which a hydrazine-based alkali metal, water, and the like are contained, those in which an alkali metal, an alcohol, an amine, water, and the like are contained, and those in which an organic alkali comprising a quaternary ammonium salt, an alcohol, an amine, water, and the like are contained. In hydrazine-based etchants, an ability to dissolve a polyimide is strong, but toxicity is strong, and there are problems, such as the inflammation of a mucous membrane due to the suction of vapor, and therefore, it is preferred to use non-hydrazine-based etchants.

An etchant containing an alkali metal hydroxide, water, and oxyalkylamine is preferred in terms of low toxicity, a wide range of application to various adhesives, high etching speed and the like. Particularly, it is more preferred that oxyalkylamine be ethanolamine, in terms of making a fine pattern shape.

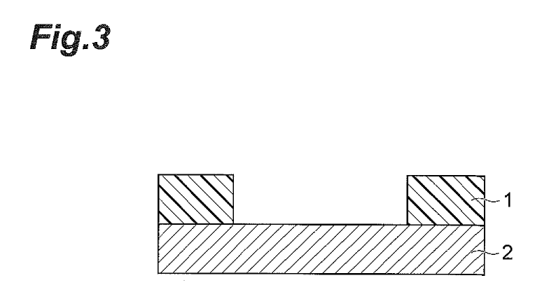

Through the above steps, an adhesive pattern is formed on the first adherend (see FIG. 3). In FIG. 3, one in which the resist pattern is removed is shown.

The removal of the resist pattern can be performed, for example, by dipping in a developer or a stripper for the resist to swell the resist.

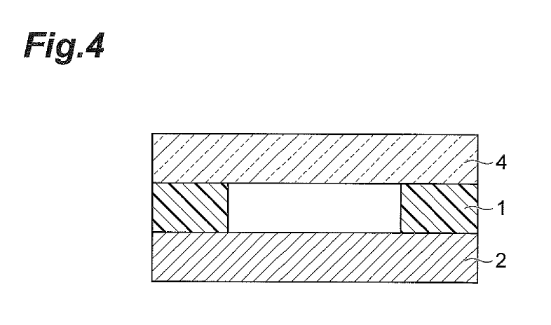

Next, a second adherend is bonded to the adhesive pattern with the resist pattern removed. Thus, an adhesion body in which the first adherend 2 and a second adherend 4 are bonded to each other via the adhesive pattern 1 as shown in FIG. 4 is obtained.

In a structure having an adhesive pattern such as shown in FIG. 4, it is difficult to bond the first adherend and the second adherend, compared with a same size structure having a bonding layer in which pattern formation is not performed. In the case of bonding the first adherend having an adhesive pattern to the second adherend, there is a part with the adhesive and a part without the adhesive, and therefore the pressure at the time of bonding is exerted nonuniformly, and accordingly there is a concern for deformation of the adherend, resin collapse or the like. In addition, the adhered area to the adherend becomes small due to patterning, and therefore the resistance to the stress exerted on the adhesive by external stress such as heat or force is more strongly needed. Therefore, not only flatness, also stickiness (such as spreading wetting depending on compression bonding temperature, or curing speed), stress relaxation, or adhesion may be required. In addition, the structure having an adhesive pattern such as shown in FIG. 4 may take a structure having a hollow part closed by the adhesive. In such a structure, it is often necessary to suppress dew condensation generated in the hollow part when left to stand under high humidity environment, and accordingly the control of close adhesiveness to the adherend interface or moisture permeability is needed for the adhesive pattern. In the method for manufacturing an adhesion body according to this embodiment, as pattern formation is performed by etching, there is no need to provide photosensitivity, printability or the like in the design of materials making up the adhesive layer, and therefore a great advantage of the method for manufacturing an adhesion body according to this embodiment is that it becomes easier to cope with the above requirement characteristics.

Examples of the second adherend include glass substrates, transparent resins (for example, acrylic resins, polycarbonate resins, and styrene-based special transparent resins, such as methyl methacrylate-styrene resins, transparent ABS resins, and methyl methacrylate-butadiene-styrene), Si wafers, organic substrates, metal substrates, and ceramic substrates.

The sticking of the second adherend can be performed by a publicly known method, such as a method of performing compression bonding while applying a load on a hot plate. In addition, a temperature condition during the compression bonding is preferably 60° C. to 200° C.

Then, by thermally curing the adhesive pattern, an adhesion body having sufficient adhesion strength can be obtained. The curing temperature of the adhesive pattern is preferably 60 to 300° C., and more preferably 80° C. or more from a relationship between stability at room temperature and curing speed, and more preferably 200° C. or less in terms of the deformation of electronic member parts and energy conservation.

In the adhesion body, it is preferred that adhesion strength at 260° C. after the adhesion body is placed in an environment of a temperature of 85° C. and a humidity of 85% for 48 hours be 0.3 MPa or more.

Examples of the adhesion body obtained by the present invention include a solid-state image pickup device in which the combination of the first adherend and the second adherend is a glass substrate and a Si substrate, a solid-state image pickup device in which the combination of the first adherend and the second adherend is a transparent resin and a Si substrate, and a MEMS device in which the combination of the first adherend and the second adherend is a transparent resin and a ceramic substrate.

In the method for manufacturing an adhesion body according to the present invention, various changes are possible. For example, it is also possible to use the etchant that is used when the adhesive layer is etched, as the developer for the resist layer or the stripper for the resist pattern. In this case, it is possible to simultaneously perform the development of the resist layer and the etching of the adhesive layer, or to remove the resist layer simultaneously with the etching of the adhesive layer by adjusting the thickness of the resist layer, using a difference in etching rate between the adhesive layer and the resist layer. By using such steps, it is possible to reduce the number of steps in the manufacturing of the adhesion body.

A substrate with an adhesive pattern according to the present invention can be obtained by performing the steps up to the etching step, among the above-described steps. In a state in which a resist is present on an adhesive pattern surface, storage and transport are possible, and workability is excellent. In addition, an effect of the substrate with an adhesive pattern according to the present invention is that wettability on an adherend is better and adhesiveness is higher, compared with those in which an adhesive pattern is formed using a photosensitive adhesive. Further, the substrate with an adhesive pattern according to the present invention is excellent in the storage stability of an adhesive, and compatibility with low-temperature stickiness is possible.

It is preferred that the adhesive pattern be formed using the above-described adhesive film. The adhesive film is preferably one in which wet etching is possible even after it is thermally cured. A state after being thermally cured in the present invention indicates a state in which, when one in which a substrate is bonded to an adherend via an adhesive pattern formed by etching is prepared and subjected to heating conditions, an adhesion film is subjected to heating conditions in which adhesion strength after heating is 1.2 times or more adhesion strength before heating.

It is preferred that the surface roughness of the adhesive pattern be 5 μm or less in terms of suppressing void occurrence. The surface roughness here refers to a difference between the maximum convex portion and the most concave portion of a surface shape obtained by measuring an adhesive pattern surface at a feed speed of 0.5 mm/s, using a surface roughness measuring instrument Surfcorder SE-2300 (manufactured by Kosaka Laboratory Ltd.).

The substrate on which the adhesive pattern is to be formed, in the present invention, is not particularly limited as long as it is a substrate that is not affected by an etchant, and examples of the substrate include semiconductor wafers, glass substrates, transparent resin substrates, ceramic substrates, and metal substrates.

In addition, in a state in which the resist is present on the surface of the adhesive pattern formed on the substrate, storage and transport are possible without scratching the surface of the adhesive pattern, and therefore, workability is excellent.

The adhesive layer in this embodiment may be made up of an adhesive having a composition other than those above-described, as long as it exhibits adhesiveness to the adherend. It is preferred that the adhesive layer be one in which the shear strength when the adhesive pattern bonded to the second adherend is cured is 1.2 times or more the shear strength before the curing of the adhesive pattern bonded to the second adherend. In this case, it can be judged that the adhesive layer has sufficient adhesiveness.

In addition, it is preferred that the adhesive layer be one in which the shear strength when the adhesive pattern having a thickness of 25 μm bonded to the second adherend is cured is 0.5 MPa or more.

The above shear strength can be determined by measuring the stress when an external force in a shear direction was applied on the first adherend side, for a sample in which the first adherend and the second adherend are bonded to each other via the adhesive pattern.

The substrate with an adhesive pattern according to the present invention can be bonded, via the adhesive pattern, to metals, such as iron, copper, silver, nickel, and palladium, alloys containing these metals, or metal oxides. Examples of the alloy include alloy 42 leadframe, and SUS. In addition, the substrate with an adhesive pattern according to the present invention can be mounted well with a semiconductor chip, by making the adhesive pattern a die bonding film pattern.

### EXAMPLES

The present invention will be more specifically described below by giving Examples. However, the present invention is not limited to the following Examples.

### Synthesis of Thermoplastic Resins Having Imide Skeleton

### Synthesis Example 1

32.8 g (0.08 moles) of 2,2-bis(4-aminophenoxyphenyl)propane (hereinafter abbreviated as “BAPP”), 4.09 g (0.02 moles) of aliphatic polyether diamine (“B-12” manufactured by BASF, hereinafter abbreviated as “B-12”), and 100 g of dimethylacetamide were placed in a 500 ml four-neck flask equipped with a thermometer, a stirrer, and a calcium chloride tube, and stirred. After the dissolution of diamine, 51.4 g (0.10 moles) of decamethylenebistrimellitate dianhydride (hereinafter abbreviated as “DBTA”) was added in small amounts, while the flask was cooled in an ice bath. After the completion of the addition, a reaction was performed in the ice bath for 3 hours, and further at room temperature for 4 hours, and then, 25.5 g (0.25 moles) of acetic anhydride and 19.8 g (0.25 moles) of pyridine were added and stirred at room temperature for 2 hours. The reaction liquid was poured into water, and a precipitate was collected by filtration and dried to obtain a thermoplastic resin A having an imide skeleton.

### Synthesis Example 2

41 g (0.1 moles) of BAPP and 150 g of dimethylacetamide were placed in a 500 ml four-neck flask equipped with a thermometer, a stirrer, and a calcium chloride tube, and stirred. After the dissolution of diamine, 41 g (0.1 moles) of ethylenebistrimellitate dianhydride was added in small amounts, while the flask was cooled in an ice bath. After a reaction was performed at room temperature for 3 hours, 30 g of xylene was added, and heating was performed at 150° C., while an N₂ gas was blown in, to azeotropically remove the xylene with water. The reaction liquid was poured into water, and a precipitate was collected by filtration and dried to obtain a thermoplastic resin B having an imide skeleton.

### Synthesis Example 3

32.8 g (0.08 moles) of BAPP, 3.97 g (0.02 moles) of B-12, and 100 g of dimethylacetamide were placed in a 500 ml four-neck flask equipped with a thermometer, a stirrer, and a calcium chloride tube, and stirred. After the dissolution of diamine, 10.4 g (0.02 moles) of decamethylenebistrimellitate dianhydride and 24.8 g (0.08 moles) of 4,4′-oxydiphthalic dianhydride (hereinafter abbreviated as “ODPA”) were added in small amounts, while the flask was cooled in an ice bath. After the completion of the addition, a reaction was performed in the ice bath for 3 hours, and further at room temperature for 4 hours, and then, 25.5 g (0.25 moles) of acetic anhydride and 19.8 g (0.25 moles) of pyridine were added and stirred at room temperature for 2 hours. The reaction liquid was poured into water, and a precipitate was collected by filtration and dried to obtain a thermoplastic resin C having an imide skeleton.

### Synthesis Example 4

A 500 ml four-neck flask equipped with a thermometer, a stirrer, and a cooler was N₂-replaced, and 55 g of 2-(1,2-cyclohexacarboxylmide)ethyl acrylate (“ARONIX M-140” manufactured by TOAGOSEI CO., LTD., hereinafter abbreviated as “M-140”), 160 g of methyl ethyl ketone (hereinafter abbreviated as “MEK”), and 2 g of α,α′-azobisisobutyronitrile were placed, and stirred at room temperature for 5 minutes. After a reaction was performed in a warm bath at 65° C. for 4 hours, and further at 68° C. for 1.5 hours, stirring was performed at room temperature for 1 hour. The reaction liquid was poured into water, and a precipitate was collected by filtration and dried to obtain a thermoplastic resin D having an imide skeleton.

### Synthesis Example 5

16.4 g (0.04 moles) of BAPP, 104.76 g (0.06 moles) of polysiloxane diamine (“KF-8010” manufactured by Shin-Etsu Silicone Co., Ltd., hereinafter abbreviated as “KF-8010”), and 150 g of dimethylacetamide were placed in a 500 ml four-neck flask equipped with a thermometer, a stirrer, and a calcium chloride tube, and stirred.

After the dissolution of diamine, 41 g (0.08 moles) of ODPA and 13.3 g (0.02 moles) of DBTA were added in small amounts, while the flask was cooled in an ice bath. After a reaction was performed at room temperature for 3 hours, 30 g of xylene was added, and heating was performed at 150° C., while an N₂ gas was blown in, to azeotropically remove the xylene with water. The reaction liquid was poured into water, and a precipitate was collected by filtration and dried to obtain a thermoplastic resin E.

### Synthesis Example 6

30.7 g (0.035 moles) of aliphatic polyether diamine (“D-400” manufactured by MITSUI FINE CHEMICALS, INC., hereinafter abbreviated as “D-400”), 22.6 g (0.065 moles) of 1,1,3,3-tetramethyl-1,3-bis(4-aminophenyl)disiloxane (“LP-7100” manufactured by Shin-Etsu Chemical Co., Ltd., hereinafter abbreviated as “LP-7100”), and 100 g of dimethylacetamide were placed in a 500 ml four-neck flask equipped with a thermometer, a stirrer, and a calcium chloride tube, and stirred. After the dissolution of diamine, 35.9 g (0.07 moles) of ODPA and 19.9 g (0.03 moles) of DBTA were added in small amounts, while the flask was cooled in an ice bath. After the completion of the addition, a reaction was performed in the ice bath for 3 hours, and further at room temperature for 4 hours, and then, 25.5 g (0.25 moles) of acetic anhydride and 19.8 g (0.25 moles) of pyridine were added and stirred at room temperature for 2 hours. The reaction liquid was poured into water, and a precipitate was collected by filtration and dried to obtain a thermoplastic resin F.

### Synthesis Example 7

7.94 g (0.04 moles) of B-12, 60 g (0.03 moles) of aliphatic polyether diamine (“D-2000” manufactured by MITSUI FINE CHEMICALS, INC., hereinafter abbreviated as “D-2000”), 14 g (0.03 moles) of 1,12-diaminododecane (hereinafter abbreviated as “DDO”), and 150 g of dimethylacetamide were placed in a 500 ml four-neck flask equipped with a thermometer, a stirrer, and a calcium chloride tube, and stirred. After the dissolution of diamine, 52 g (0.1 moles) of 4,4′-(4,4′-isopropylidenediphenoxy)bis(phthalic dianhydride) (hereinafter abbreviated as “BPADA”) was added in small amounts, while the flask was cooled in an ice bath. After a reaction was performed at room temperature for 3 hours, 30 g of xylene was added, and heating was performed at 150° C., while an N₂ gas was blown in, to azeotropically remove the xylene with water. The reaction liquid was poured into water, and a precipitate was collected by filtration and dried to obtain a thermoplastic resin G.

### Synthesis Example 8

1.89 g (0.01 moles) of 3,5-diaminobenzoic acid (hereinafter abbreviated as “DABA”), 15.21 g (0.03 moles) of D-400, and 0.39 g (0.001 moles) of LP-7100, and 116 g of N-methyl-2-pyrrolidinone (hereinafter abbreviated as “NMP”) were placed in a flask equipped with a stirrer, a thermometer, a cooling tube, and a nitrogen purger. Then, 16.88 g (0.033 moles) of ODPA was added in the above flask in small amounts, while the flask was cooled in an ice bath. After the completion of the addition, further stirring was performed at room temperature for 5 hours. Next, a reflux cooler with a water receptor was mounted to the flask, and 70 g of xylene was added, and while a nitrogen gas was blown in, temperature was raised to 180° C. and this temperature was maintained for 5 hours, to azeotropically remove the xylene with water. The thus obtained solution was cooled to room temperature, and then put into distilled water to be reprecipitated. The obtained precipitate was dried with a vacuum dryer to obtain a thermoplastic resin H.

### Examples 1 to 8

Varnishes having compositions as shown in Table 1 and 2 were formulated, using the above thermoplastic resins A to H as a thermoplastic resin having an imide skeleton, respectively.

TABLE 1

| | | | Ex- | Ex- | Ex- |
|---|---|---|---|---|---|
| | | Example 1 | ample 2 | ample 3 | ample 4 |
| Thermoplastic | Thermoplastic | 100 | | | |
| resin having | resin A | | | | |
| imide skeleton | Thermoplastic | | 100 | | |
| (parts by | resin B | | | | |
| mass) | Thermoplastic | | | 100 | |
| | resin C | | | | |
| | Thermoplastic | | | | 100 |
| | resin D | | | | |
| Thermosetting | YDCN702S | 11.5 | 6 | 12 | |
| component | BEO-60E | | | | 11.5 |
| (parts by | | | | | |
| mass) | | | | | |
| Curing agent | VH-4170 | 6 | | | |
| (parts by | TrisP-PA | | 5 | 7 | 8 |
| mass) | | | | | |
| Filler (parts | HP-P1 | 11 | 10 | 10.7 | 11 |
| by mass) | | | | | |
| Solvent | NMP | 150 | 150 | 150 | |
| (parts by | MEK | | | | 150 |
| mass) | | | | | |

TABLE 2

| | | | Ex- | Ex- | Ex- |
|---|---|---|---|---|---|
| | | Example 5 | ample 6 | ample 7 | ample 8 |
| Thermoplastic | Thermoplastic | 100 | | | |
| resin having | resin A | | | | |
| imide skeleton | Thermoplastic | | 100 | | |
| (parts by | resin B | | | | |
| mass) | Thermoplastic | | | 100 | |
| | resin C | | | | |
| | Thermoplastic | | | | 100 |
| | resin D | | | | |
| Thermosetting | YDCN702S | 12 | 12 | 12 | 12 |
| component | BEO-60E | | | | |
| (parts by | | | | | |
| mass) | | | | | |
| Curing agent | VH-4170 | 8 | 8 | 8 | 8 |
| (parts by | TrisP-PA | | | | |
| mass) | | | | | |
| Filler (parts | HP-P1 | 11 | 11 | 11 | 11 |
| by mass) | | | | | |
| Solvent | NMP | 150 | 150 | 150 | 150 |
| (parts by | MEK | | | | |
| mass) | | | | | |

Symbols in Table 1 and 2 represent the following compounds.

YDC702S: a trade name of Tohto Kasei Co., Ltd., a cresol novolac type epoxy resin
BEO-60E: a trade name of New Japan Chemical Co., Ltd., an ethylene oxide adduct bisphenol type epoxy resin
VH-4170: a trade name of DIC Corporation, bisphenol A novolac
TrisP-PA: a trade name of Honshu Chemical Industry Co., Ltd., trisphenol novolac, chemical name: 4,4′-[1-[4-[1-(4-hydroxyphenyl)-1-methylethyl]phenyl]ethylidene]bisphenol
HP-P1: a trade name of Mizushima Ferroalloy Co., Ltd., boron nitride

### NMP: N-methylpyrrolidone

MEK: methyl ethyl ketone

Each of the varnishes prepared above was applied on a PET film, with a thickness of 30 to 50 μm, and heated at 80° C. for 10 minutes, and then at 120° C. for 10 minutes to obtain adhesion films having a thickness of 25 μm in Examples 1 to 8.

### Comparative Examples 1 to 4

The following films were prepared as adhesion films for comparison.

Comparative Example 1: an adhesion film obtained by applying the thermoplastic resin A on a PET film that is surface-treated with a silicone for release, and drying to form the thermoplastic resin A into a film shape having a thickness of 25 μm
Comparative Example 2: a die bonding film HIATTACH series FH-900 (film thickness: 25 μm, manufactured by Hitachi Chemical Co., Ltd., a thermosetting adhesion film comprising no thermoplastic resin having an imide skeleton)
Comparative Example 3: a coverlay film RAYTEC FR-5950 (film thickness: 38 μm, manufactured by Hitachi Chemical Co., Ltd., a photoresist in which a resist pattern can be formed by exposure and development)
Comparative Example 4: a die bonding film HIATTACH series DF-112P (film thickness: 25 μm, manufactured by Hitachi Chemical Co., Ltd., a photosensitive adhesion film that comprises a photosensitive polyimide resin and can be patterned without a resist and adhered)

<Evaluation of Pattern Formation Properties, the Number of Voids Between the Adhesive Pattern and the Bare Wafer, and Shear Strength>

In order to evaluate the adhesion strength of the adhesive pattern in the present invention, experiments were conducted to measure share strength as shown in the examples below.

For evaluation items, pattern formation properties by etching, the number of voids between the adhesive pattern, and the shear strength of the adhesive pattern were evaluated by methods shown below. Evaluation results are shown together in Table 2.

[Pattern Formation Properties]

Each of the films of Examples 1 to 8 and Comparative Examples 1 to 4 was laminated on a 10 cm×10 cm×500 μm glass (MATUNAMI Micro Cover GLASS No. 5) at a temperature of 150° C. (60° C. for Example 8 and Comparative Examples 2 to 4), a pressure of 0.4 MPa, and a roll speed of 0.5 mm/min, using an apparatus having a roll and a support (VA-400II manufactured by TAISEI LAMINATOR CO., LTD.). Then, for the adhesion films other than those of Comparative Examples 3 and 4, a substrate was removed, and a photosensitive coverlay film RAYTEC FR-5950 (film thickness: 38 μm, manufactured by Hitachi Chemical Co., Ltd.) as a resist was laminated on the adhesive layer at a temperature of 60° C., a pressure of 0.4 MPa, and a roll speed of 0.5 mm/min, using an apparatus having a roll and a support (VA-400II manufactured by TAISEI LAMINATOR CO., LTD.). A photomask (a negative photomask with opening: a 2.4 mm×2.4 mm square, and rib width: 1.0 mm) was placed thereon, and ultraviolet rays were emitted from a PET film side under the condition of exposure amount: 500 mJ/cm², using a high-precision parallel exposure machine (manufactured by ORC MANUFACTURING CO., LTD., using an ultra-high-pressure mercury lamp). For Comparative Examples 3 and 4, RAYTEC FR-5950 was not laminated, and ultraviolet rays were emitted from a PET side under the condition of an exposure amount of 500 mJ/cm², using the same exposure apparatus, and for Comparative Example 4, within 5 minutes after exposure, a sample was further allowed to stand on a hot plate at 80° C. for 1 minute.

Then, the PET films of all samples were removed, and each sample was spray-developed at a pressure of 1.0 kgf/cm² for 40 seconds (30 seconds for Comparative Example 4 only), using a tetramethylammonium hydride (TMAH) 2.38% solution. Then, the sample was water-washed for 60 seconds, and it was confirmed that a resist pattern was formed (an adhesive pattern was formed for Comparative Examples 3 and 4).

Then, the samples other than those of Example 8 and Comparative Examples 3 and 4 were etched using a polyimide etchant (TPE-3000, manufactured by Toray Engineering Co., Ltd., potassium hydroxide: 28.2% by mass, monoethanolamine: 33.7% by mass, water: 38.1% by mass) at a liquid temperature of 60° C. for 10 minutes. The samples in which the etching was completed within 10 minutes were removed at the point of the completion. For Example 8, using a TMAH 2.38% solution, it was confirmed that the etching was completed at 26° C. for 1 minute. Then, each sample was impregnated in a container containing a TMAH 2.38% solution for about 30 seconds to swell the resist and remove the resist.

For the thus obtained samples, the adhesive layer in portions protected from the etchant by the resist, and the adhesive layer in 2.4 mm×2.4 mm square portions where the resist was removed were visually observed, and the samples were evaluated based on the following determination criteria.

A: the adhesive layer in the portions protected from the etchant by the resist remains bonded to the glass, and the adhesive layer in the portions where the resist is removed is all removed by etching, and the glass is visually seen.
B: there are residues in the portions where the resist is removed, or there are portions where etching is insufficient and the glass is not seen.

[The Number of Voids Between the Adhesive Pattern and the Bare Wafer]

After each sample for which the pattern formation properties were evaluated was water-washed with distilled water, and the water was blown away by an air gun, a 5-inch bare wafer having a thickness of 400 μm was bonded at a temperature of 180° C. and a pressure of 0.5 MPa for a time of 90 seconds, using a bonding apparatus (manufactured by Ayumi Industries Company Limited). For the thus obtained samples, an interface between the adhesive pattern and the bare wafer was visually observed from a glass side, and a case where the number of voids having a diameter of 3 mm or more was 10 or less was determined as A, and a case where the number of voids having a diameter of 3 mm or more was more than 10 was determined as B.

[Shear Strength-1]

A pressure-sensitive dicing tape was laminated on the glass side of each sample for which the pattern formation properties were evaluated. Then, the glass, together with the adhesive layer, was cut to a 3.4 mm×3.4 mm size, using a dicer, to obtain a glass chip on which the adhesive layer was laminated. A dicing line at this time was the center of the adhesive pattern, and the adhesive pattern on the obtained glass chip was a frame pattern.

The thus obtained glass chip with an adhesive pattern was placed on a 10 mm×10 mm×0.4 mm thick silicon chip, with an orientation in which the adhesive pattern was sandwiched between the silicon chip and the glass chip, and thermocompression-bonded on a hot plate at 180° C. under the conditions of 500 gf and 10 seconds, and thereby 20 samples were made. Then, 10 of the 20 samples were heated in an oven at 180° C. for 1 hour to heat and cure the adhesive pattern. After the obtained samples after the curing and the samples before the curing were placed on a hot plate at 260° C. for 20 seconds, an external force in a shear direction was applied on a glass chip side under the conditions of measurement speed: 50 μm/sec and measurement height: 50 μm, using an adhesion tester “Dage-4000” (trade name) manufactured by Dage. The average stress of 10 samples at this time was measured as the shear strength after the curing and the shear strength before the curing, respectively. The values of shear strength are shown in Table 3. As a determination of adhesiveness, a case where the shear strength after the curing was 0.5 MPa or more was determined as A, and a case where the shear strength after the curing was less than 0.5 MPa was determined as B.

[Shear Strength-2]

The samples were prepared in which the adhesive pattern was formed on a 6 inch Si wafer, instead of the 10 cm×10 cm×500 μm glass in the making of the samples for which the pattern formation properties were evaluated, in a similar procedure. A similar operation to that of Shear Strength-1 was performed on these samples that are adhered to an alloy 42 leadframe used instead of the 10 mm×10 mm×0.4 mm thick silicon chip, to produce before-curing samples and after-curing samples. After the obtained samples after the curing and the samples before the curing were placed on a hot plate at 260° C. for 20 seconds, an external force in a shear direction was applied on a silicon chip side under the conditions of measurement speed: 50 μm/sec and measurement height: 50 μm, using an adhesion tester “Dage-4000”. The average shear strength of 10 samples at this time was measured as the shear strength after the curing and the shear strength before the curing, respectively. The values of shear strength are shown in Table 3. As a determination of adhesiveness, a case where the shear strength after the curing was 1.2 times or more the shear strength before the curing was determined as A, and a case where the shear strength after the curing was less than 1.2 times the shear strength before the curing was determined as B.

TABLE 3

| | | The | | | | | | |
|---|---|---|---|---|---|---|---|---|
| | | number | | | | | | |
| | | of voids | | | | | | |
| | | between | | | | | | |
| | | the | | | | | | |
| | | adhesive | Shear strength-1 | | | Shear strength-2 | | |
| | | pattern | | Before | After | | Before | After |
| | Pattern | and the | | the | the | | the | the |
| | formation | bare | | curing | curing | | curing | curing |
| | properties | wafer | Determination | (MPa) | (MPa) | Determination | (MPa) | (MPa) |
| Example 1 | A | A | A | 0.03 | 0.62 | A | 0.04 | 1.18 |
| Example 2 | A | A | A | 0.04 | 0.75 | A | 0.03 | 1.07 |
| Example 3 | A | A | A | 0.04 | 0.81 | A | 0.04 | 1.21 |
| Example 4 | A | A | A | 0.02 | 0.51 | A | 0.03 | 0.72 |
| Example 5 | A | A | A | 0.04 | 1.20 | A | 0.05 | 1.23 |
| Example 6 | A | A | A | 0.04 | 0.95 | A | 0.04 | 1.06 |
| Example 7 | A | A | A | 0.05 | 0.63 | A | 0.06 | 0.99 |
| Example 8 | A | A | A | 0.02 | 0.78 | A | 0.05 | 0.95 |
| Comparative | A | A | B | 0.10 | 0.10 | B | 0.13 | 0.12 |
| Example 1 | | | | | | | | |
| Comparative | B | A | A | 0.10 | 1.30 | A | 0.10 | 2.30 |
| Example 2 | | | | | | | | |
| Comparative | A | B | B | 0.01 | 0.01 | B | 0.12 | 0.13 |
| Example 3 | | | | | | | | |
| Comparative | A | B | A | 0.10 | 2.00 | A | 0.10 | 1.40 |
| Example 4 | | | | | | | | |

As shown in the table, in the adhesion films according to the Examples, all of pattern formation properties by etching, the number of voids between the adhesive pattern and the bare wafer, and shear strength were excellent. On the other hand, in Comparative Example 1 using an adhesion film comprising a thermoplastic resin having an imide skeleton but comprising no thermosetting component, the shear strength after the curing was 0.1 MPa and hot adhesion strength was low. In Comparative Example 2 using a commercially available die bonding film, the stickiness and the shear strength were good, but pattern formation was not possible. Comparative Example 3 using a commercially available photoresist was inferior in the number of voids between the adhesive pattern and the bare wafer, shear strength, and the like. In Comparative Example 4 using a commercially available photosensitive adhesion film, the adhesive pattern became hard because Comparative Example 4 had a component cured by light, and in addition, a large number of voids occurred at the time of bonding because surface roughness due to development occurred.

### DESCRIPTION OF SYMBOLS

1: adhesive layer, 2: first adherend, 3: resist, 4: second adherend, 5: mask

What is claimed is:

1. A method for manufacturing an adhesion body in which a first adherend and a second adherend are bonded to each other via an adhesive pattern, comprising:
a step of providing an adhesive layer containing a thermosetting component on a first adherend;
a step of forming an adhesive pattern by etching the adhesive layer in a state in which a protective layer for protecting a predetermined portion of the adhesive layer from etching is provided on a surface of the adhesive layer opposite to a surface in contact with the first adherend; and
a step of bonding a second adherend to the adhesive pattern after the protective layer is removed.

2. The method according to claim 1, wherein the adhesive layer further contains a thermoplastic resin having an imide skeleton.

3. A method for manufacturing an adhesion body in which a first adherend and a second adherend are bonded to each other via an adhesive pattern, comprising:
a step of providing an adhesive layer on a first adherend;
a step of forming an adhesive pattern by etching the adhesive layer in a state in which a protective layer for protecting a predetermined portion of the adhesive layer from etching is provided on a surface of the adhesive layer opposite to a surface in contact with the first adherend; and
a step of bonding a second adherend to the adhesive pattern after the protective layer is removed,
wherein the adhesive layer is one in which the shear strength when the adhesive pattern bonded to the second adherend is cured is 1.2 times or more the shear strength before the curing of the adhesive pattern bonded to the second adherend.

4. The method according to claim 1, wherein the protective layer is a resist pattern formed by providing a resist layer comprising a photosensitive resin composition on the surface of the adhesive layer opposite to the surface in contact with the first adherend, and exposing and developing the resist layer.

5. The method according to claim 3, wherein the protective layer is a resist pattern formed by providing a resist layer comprising a photosensitive resin composition on the surface of the adhesive layer opposite to the surface in contact with the first adherend, and exposing and developing the resist layer.

6. The method according to claim 1, wherein the etching is wet etching.

7. The method according to claim 3, wherein the etching is wet etching.

8. A method for manufacturing a substrate with an adhesive pattern, comprising:
a step of providing an adhesive layer containing a thermosetting component on a substrate; and
a step of forming an adhesive pattern by etching the adhesive layer in a state in which a protective layer for protecting a predetermined portion of the adhesive layer from etching is provided on a surface of the adhesive layer opposite to a surface in contact with the substrate.

9. The method according to claim 8, wherein the adhesive layer further contains a thermoplastic resin having an imide skeleton.

10. A substrate with an adhesive pattern, comprising:
a substrate; and
an adhesive pattern formed by etching an adhesive layer containing a thermosetting component provided on the substrate.

11. The substrate according to claim 10, wherein the adhesive layer further contains a thermoplastic resin having an imide skeleton.
